(19) United States
(12) Patent Application Publication
(10) Pub. No.: US 2005/0027589 A1
(43) Pub. Date: Feb. 3, 2005

(54) System and method for electronically managing a cleaning organization and services rendered to clients

(75) Inventors: Michael A. Jenkins, Springville, UT (US); Joseph R. Jenkins, West Jordan, UT (US); Marcelo C. Melo, West Valley City, UT (US); Aaron K. Hawkins, Payson, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: CleanBrain Software, Inc.

(21) Appl. No.: 10/629,665

(22) Filed: Jul. 28, 2003

(51) Int. Cl. G06F 17/60

(52) U.S. Cl. 705/11

(57) ABSTRACT

A system and method is provided for electronically managing a cleaning organization and services rendered to clients. According to the present invention, an electronic comment relating to a cleaning area serviced by a cleaning person within the cleaning organization is captured from a client. The electronic comment is stored in a cleaning management database as part of a historical cleaning record. The comment is also sent to a manager of the cleaning organization, and the comment is classified as part of a data group file with similar comments. The comment is communicated to a supervisor responsible for the cleaning area, and then the supervisor provides a notification obtained from the cleaning management database to the cleaning person.

### FIELD OF THE INVENTION

The present invention relates generally to electronically managing a cleaning organization.

### BACKGROUND OF THE INVENTION

Virtually everyone appreciates a well-cleaned and maintained facility. Working in a clean and organized environment is important for employees who spend time at a facility. In addition, being able to present a clean workspace to customers, visitors, and others who visit a facility is important to any business, entity, or institution. The cleanliness of a facility can greatly affect a first impression with a potential customer and can be a deciding factor in whether or not a company receives repeat business.

Regardless of whether the facility is a private company or public building, a clean facility can be a direct reflection of the institution, company, or even their products. A clean facility helps increase employee health, morale, and productivity. Since having a clean facility is fundamental to nearly any organization or business, high quality cleaning services are typically in demand and companies who provide high quality cleaning services are generally able to find a client base who desires their cleaning services.

Unfortunately, there are some obstacles to developing a quality cleaning organization. One issue in developing a quality cleaning organization and staff is the training and management of the cleaning staff. Individuals who actually perform the cleaning in a facility are typically laborers who are unskilled or untrained when they begin their cleaning employment. Although with the proper management and supervision, these individuals can become high-quality cleaning staff. High-quality cleaning may be obtained through training and certifying cleaning specialists. This training can include programs that train and certify cleaning specialists through videos, hands-on experience, and examinations. Because each facility is different, there must also be training regarding the specific facility in which a cleaner is working. In order to ensure that the cleaners, who actually clean a specific facility, are trained regarding specific facility issues, there must be an appropriate communication of building specific information and problem areas to the cleaners and staff in an accurate and timely manner.

Despite most cleaning companies' desire for high quality training and cleaning, their clients' problem cleaning areas and related issues are not typically communicated to cleaners in a timely or efficient manner. For example, when there is a problem, a client may talk to a cleaner and ask them to clean differently or more frequently. If the cleaning problems are only discussed directly with a cleaner, then this information will not be known to the cleaning company management. This direct communication may take place even though the cleaner has not been designated to receive that information because the cleaner is readily available. When a cleaner receives notice of a problem, this can reduce the management's awareness of cleaning quality problems. Another drawback in this situation is that the cleaning company management is not able to see trends in cleaning problems or understand how the cleaning company can more effectively meet the client's expectations.

Another example of a client communication problem is where the client simply calls a member of the cleaning company's management and describes a problem to a manager. The member of management is then likely to make a paper or a mental note of the problem. The cleaning management staff member can then orally convey the information or problem to the cleaner who is instructed to improve the problem. Eventually, the paper or mental notes are likely to get lost and that information may become irretrievable. In addition, orally conveyed information can be easily forgotten or misunderstood.

New cleaners who begin working at a cleaning job with the type of communication problems just described are unlikely to know about the client's previous expectations when the paper or mental notes regarding those expectations have been lost or disregarded. If the knowledge of client issues is lost when the previous cleaner terminates their employment or the management forgets about previous problems, then this can lead to unmet client expectations because a new cleaning person is unlikely to know about or address the previous problems. These communication problems can eventually lead to lost cleaning clients.

Another side effect of poor information transfer is that a new cleaner is at a disadvantage when they begin their job because they do not have information regarding specific client issues and problems. Because each client often has different expectations and desires, the new cleaner may have difficulty meeting a client's expectations without knowing exactly what those expectations are. In fact, the cleaner may be reprimanded for issues which were only communicated to the previous cleaner.

### SUMMARY OF THE INVENTION

The invention provides a system and method for electronically managing a cleaning organization and services rendered to clients. According to the present invention, an electronic comment relating to a cleaning area serviced by a cleaning person within the cleaning organization is captured from a client. The electronic comment is stored in a cleaning management database as part of a historical cleaning record. The comment is also sent to a manager of the cleaning organization, and the comment is classified as part of a data group file with similar comments. The comment is communicated to a supervisor responsible for the cleaning area, and then the supervisor provides a notification obtained from the cleaning management database to the cleaning person.

### BRIEF DESCRIPTION OF THE DRAWINGS

FIG. 1 is a flow chart illustrating an embodiment of a method for electronically managing a cleaning organization;

FIG. 2 is a block diagram illustrating a system for electronically managing a cleaning organization according to an embodiment of the present invention;

FIG. 3 is a block diagram of an embodiment of the invention for capturing an electronic comment from a client;

FIG. 4 is a block diagram of an embodiment for sending the electronic comment to management;

FIG. 5 is a block diagram of an embodiment for enabling management to classify or direct the electronic comment;

FIG. 6 is a block diagram of an embodiment for distributing the electronic comment to a supervisor;

FIG. 7 is a block diagram of an embodiment for providing a cleaning person with the notification or request report;

FIG. 8 is a block diagram of an embodiment for capturing a cleaning summary from a cleaning person into the electronic management database;

FIG. 9 is a block diagram of an embodiment for directing a cleaning module to send a cleaning summary to management;

FIG. 10 is a block diagram of an embodiment for sending a reply from management to a client;

FIG. 11 is a block diagram of an embodiment of the present invention for sending a reply from management to a client;

FIG. 12 is a block diagram of a system for electronically tracking cleaning according to an embodiment of the invention;

FIG. 13 is a flow chart illustrating method for electronically managing cleaning persons in an embodiment of the invention; and

FIG. 14 is a flow chart illustrating an embodiment of a method for managing cleaning work tickets.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

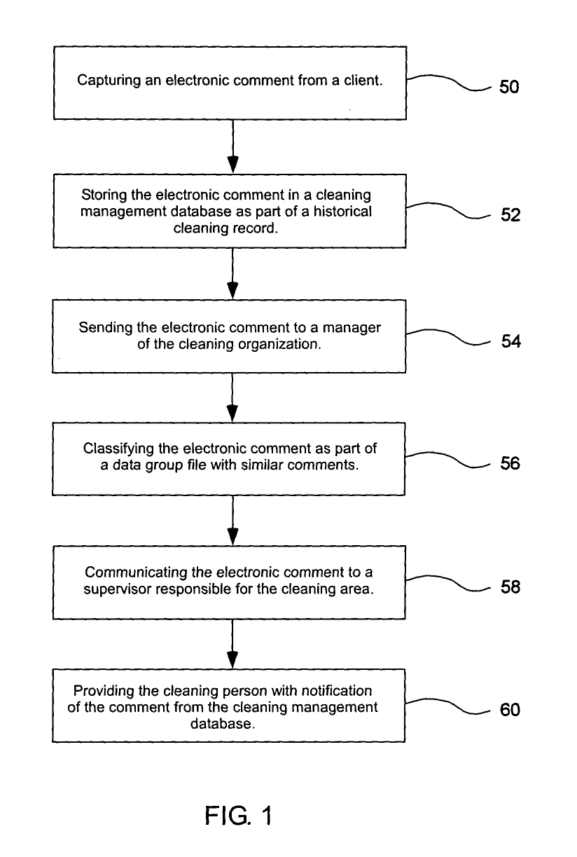

The present invention provides a system and method for electronically managing a cleaning organization and services rendered to clients. According to the embodiment of the invention illustrated in FIG. 1, a cleaning management database handles and stores cleaning information such as comments from clients who are being serviced by the cleaning organization. An electronic comment relating to a cleaning area serviced by a cleaning person within the cleaning organization is captured from a client 50. After the electronic comment is captured, the electronic comment is stored in a cleaning management database as part of a historical cleaning record 52. A manager of the cleaning organization is sent the electronic comment 54, and the electronic comment is classified as part of a data group file with similar comments 56. The electronic comment is also communicated to a supervisor who is responsible for the cleaning area 58, and a cleaning person is provided with notification of the comment from the cleaning management database 60.

Using a cleaning management database to store comments or requests from clients eliminates the difficulties of paper tracking and ensures that the comment is not lost, misplaced, forgotten or destroyed. The present invention also helps facilitate communication and increase the cleaning organization's accountability by providing copies of the client's electronic comment to the cleaning organization's management, the supervisor, and the cleaning person.

The present invention applies to numerous different application usage embodiments. According to one embodiment, the cleaning organization's management is divided into a first level of management and a second level of management. In an embodiment where the cleaning organization is a building service operation, the first level of management can be a building service's higher management and the second level of management can be the building service provider. In another embodiment, the cleaning organization may be an in-house operation. In this embodiment, the first level of management can be a facility manager over janitorial services and the second level of management can be the supervisory management over an in-house janitorial staff. The cleaning management database of the present invention can also be used to facilitate communication between a cleaning franchisor and a cleaning franchisee. A cleaning franchisor can also use the cleaning management database as a tool to manage the quality and nature of janitorial services.

A cleaning management company that is able to engage in effective and timely communications with their clients is more likely to have satisfied clients who will retain the cleaning company on a long-term basis. In addition, when management is able to convey important client information to their cleaning people in a timely and effective manner, then customer service can improve.

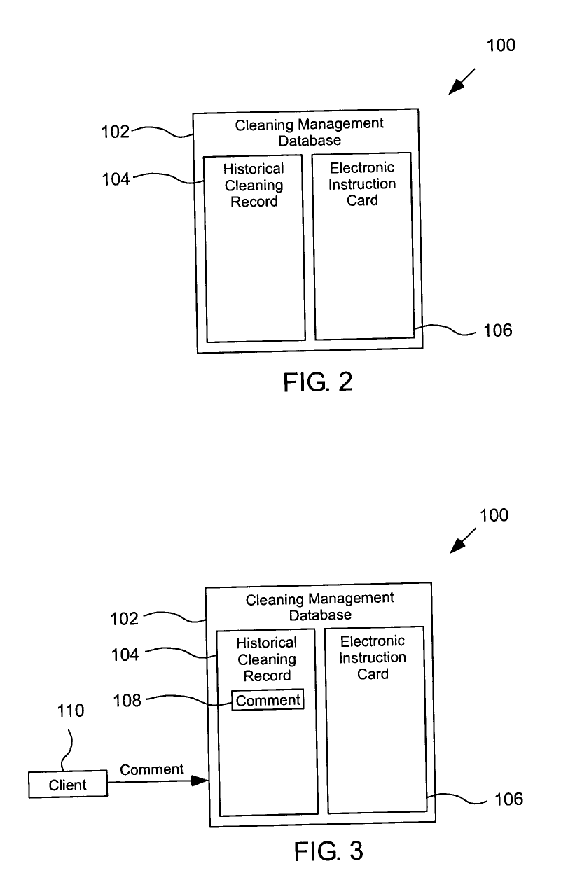

As illustrated in FIG. 2, the present invention includes a cleaning management database for storing and managing cleaning comments. The cleaning organization will generally have an agreement to perform certain cleaning duties for the client. The client 110 can enter comments 108 into the cleaning management database 102, as illustrated in FIG. 3. These comments may be complaints because the cleaning people did not perform the duties outlined in a contract in a satisfactory manner. Alternatively, the comments can also be more detailed instructions on how to clean certain areas, or requests to perform additional duties not outlined in the original cleaning agreement.

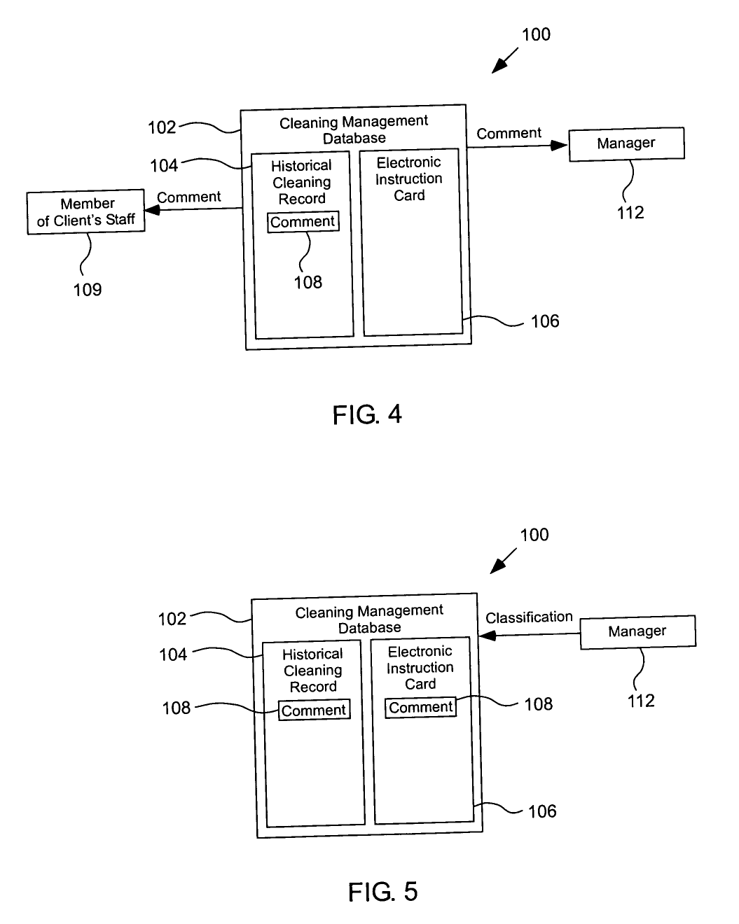

FIG. 4 illustrates that the electronic comment 108 is sent to a manager of the cleaning organization 112 and stored in the cleaning management database 102 as part of the historical cleaning record 104. The manager may set a classification for the electronic comment that groups the comment with other similar comments, as in FIG. 5. The electronic comment can also be assigned to an electronic instruction card 106 used by the cleaning person in the process of performing cleaning duties. The electronic instruction card, which can also be a job card or a specialist card, is updated to include the electronic comment so that the electronic comment can be communicated to current and future cleaning people.

The information included in the electronic instruction card tells the cleaning person exactly what to do to insure that the cleaning area associated with the card is cleaned according to the cleaning agreement with the client. Each cleaning person's position can have an instruction card associated with it. The instruction card can detail the cleaning tasks and frequency for daily, weekly, monthly, quarterly, semi-annual, and annual projects based on the actual cleaning agreement. The cards also provide information regarding the client's specific needs, areas of concern, and additional instructions. The cards are automatically updated with selected communications sent between the client and the cleaning organization. Because the knowledge of the client's cleaning problems and issues for a cleaning area or route stay with the instruction card, this critical information does not get lost due to cleaning person turnover. In other words, the instruction cards provide cleaning knowledge continuity and accountability to the client. Ultimately, these instruction cards lead to better cleaning and higher client satisfaction because a complete description of how to meet the client's needs or complaints can be recorded on the instruction cards.

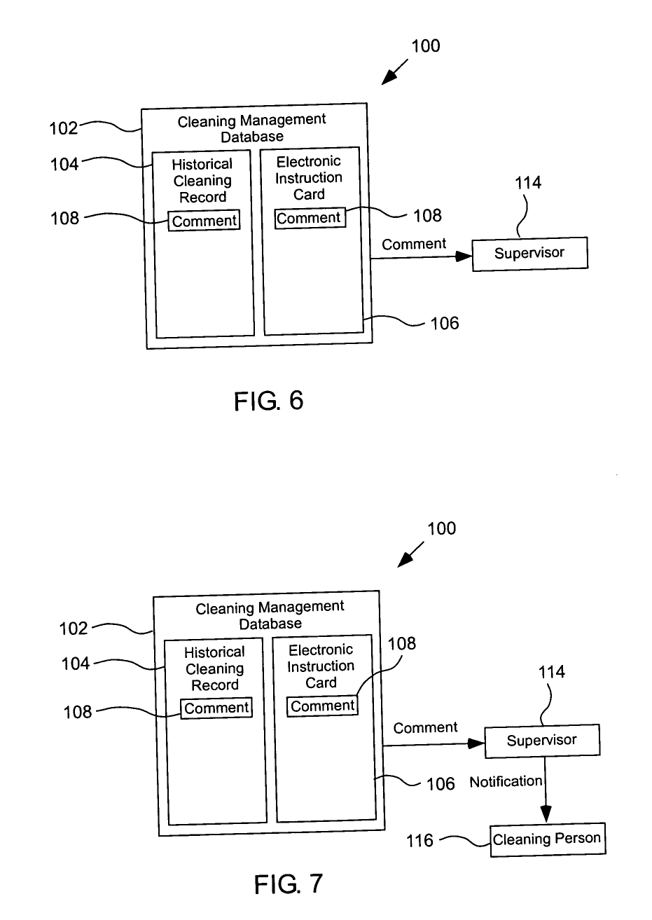

FIG. 4, FIG. 5, and FIG. 6 show that the comment can be distributed to members of the client's staff and to individuals who are responsible for a cleaning area where the client is located. According to the embodiment of the invention depicted in FIG. 4, the electronic comment can be sent to a member of the client's staff 109 in order to provide better communication between a cleaning person and a client.

As previously mentioned, the cleaning organization's management can be divided into a first and a second level of management, and the electronic comment can be sent to both of these levels of management. A second level manager can be enabled to use a cleaning management module to forward the electronic comment to the supervisor within the cleaning organization 114, as shown in FIG. 5 and FIG. 6. Alternatively, the cleaning management module can programmatically forward or route the comment to the supervisor. The cleaning management database can store information about which supervisors are associated with which cleaning areas in order to allow the cleaning management module to correctly forward the comment to a supervisor.

After the supervisor receives the comment, the supervisor provides a cleaning person 116 with notification of the comment from the cleaning management database, as shown in FIG. 7. The notification provides a cleaning person with information that allows the cleaning person to perform cleaning duties that address the client's comment or request. The notification can be a copy of the electronic comment from the cleaning person, a description of cleaning duties, a printed electronic instruction card, verbal instructions, or any form of communication to inform the cleaning person about the electronic comment. According to another embodiment, a local supervisor, or lead, receives the notification of the comment. The local supervisor can perform the work outlined in the notification or give the notification to a cleaning person. The notification can also be sent directly to the cleaning person through the cleaning management database.

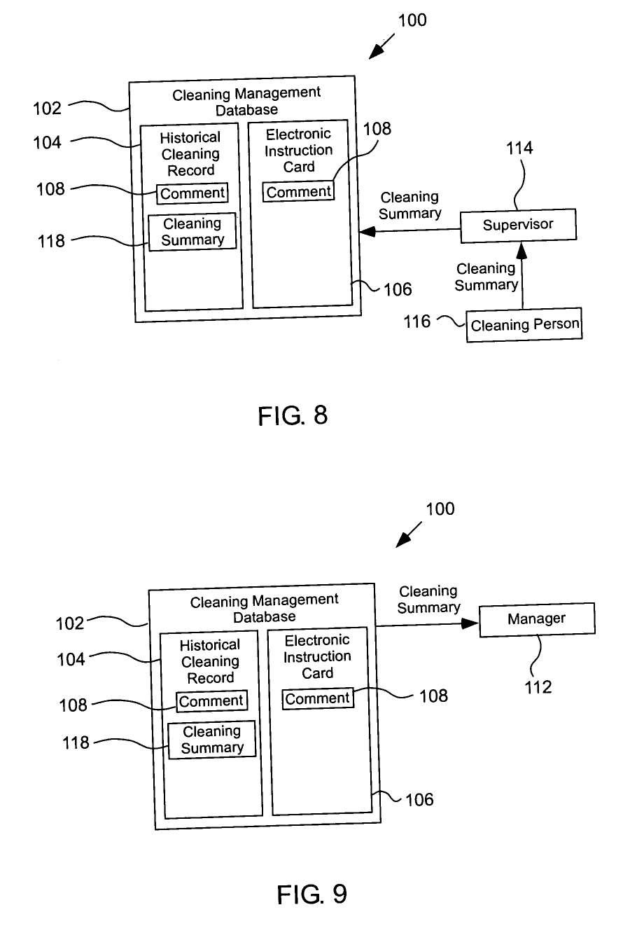

The cleaning person 116 performs the cleaning duties outlined in notification or request report and can give the supervisor a summary of the cleaning that was performed, as illustrated in FIG. 8. The cleaning summary is attached to the notification received by the cleaning person. The supervisor may then enter the cleaning summary 118 in the cleaning management database and the cleaning summary can be stored as part of the historical cleaning record. In a different embodiment of the invention, the local supervisor receives the cleaning summary from the cleaning person and enters the summary directly into the cleaning management database or gives the summary to the supervisor. A cleaning management module can then be directed to send the cleaning summary to the manager of the cleaning organization, as shown in FIG. 9.

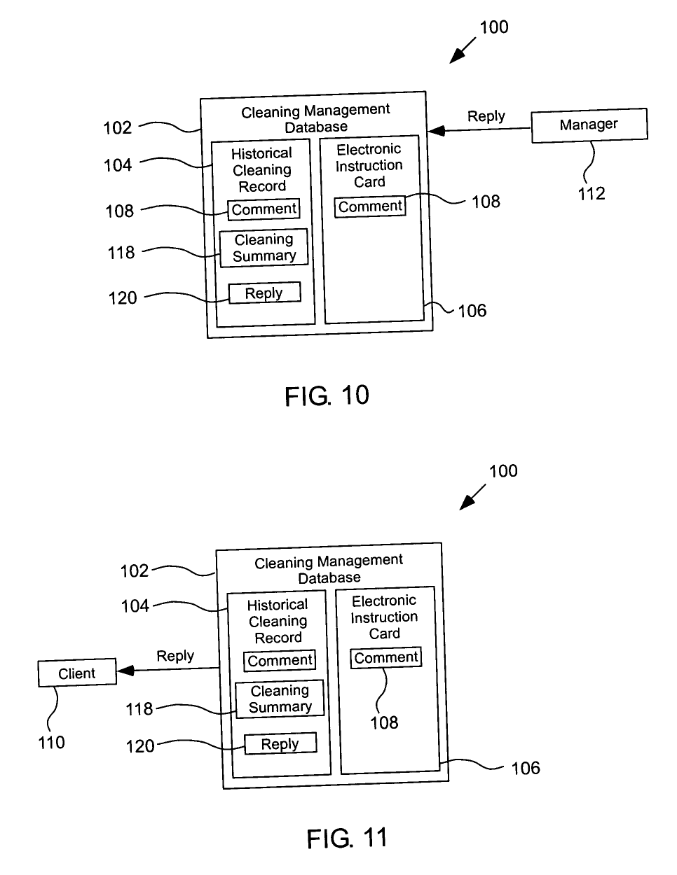

The manager 112 generates a reply to the client based on the cleaning summary from the cleaning person. The management can simply use the cleaning summary as the reply, or the manager can write a reply using information from the cleaning summary. The reply is sent through the cleaning management database to the client 110, as shown in FIG. 10 and FIG. 11. The cleaning management module can direct the reply to the client, and the reply 120 can be stored in the cleaning management database 102 as part of the historical cleaning record 104.

Access to the historical cleaning record can be provided to the cleaning person, the supervisor, the cleaning organization's management, a client's assigned user, and other assigned users. The historical cleaning record is stored with other historical cleaning information, and individuals with access to these historical cleaning records can search them. The historical cleaning records can be searched according to different categories including building, cleaning person, type of complaint, comment, and subject. Access to the communications stored in the historical cleaning record can also be simplified when the communications are connected as threads of discussion linked to the initial comment.

A telephone navigation menu can also be included in the present invention. The telephone navigation menu provides access to the cleaning management database over the telephone so that a client, member of the client's staff, or member of the cleaning organization can listen to messages from or dictate information into the electronic cleaning database over the telephone.

Providing access to historical cleaning records can improve cleaning and management. Cleaning improves because managers, supervisors, and cleaning people can check the database to see where the problems areas have been in a particular area or building and then modify their cleaning accordingly. The historical cleaning records can also be used by supervisors and managers to assess where cleaning people need to improve and training can be provided accordingly. Cleaning people can also identify clients who have made numerous complaints and give special attention to those clients.

The present invention also includes the operation of distributing the historical cleaning record to the supervisor, the client, and a manager of the cleaning organization. This can be done by email, instant messaging, telephone, or any other distribution method. If the distribution is accomplished by the telephone, the system can call the manager, client, or supervisor and dictate the information or leave the information on the voicemail. The message can also be sent directly to voicemail.

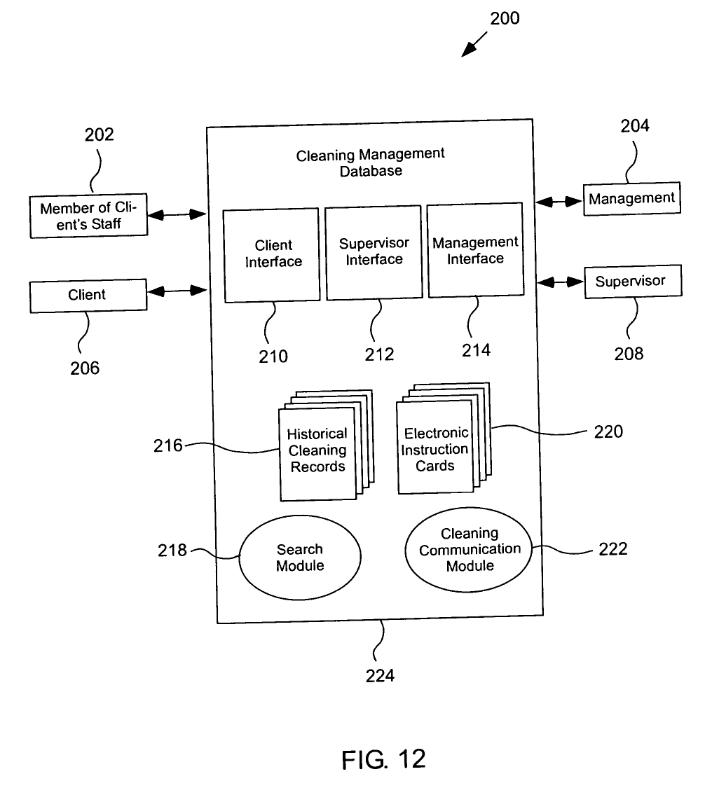

The system of the present invention is shown as a block diagram overview in FIG. 12. The system includes a cleaning management database 224. The database can be web based and stored on a server connected to the Internet. Alternatively, the database can be stored on a computer or server in a local network. There are several different views for the user interface, depending on whether the individual connecting to the database is a client, the cleaning person's management, or the cleaning person's supervisor. The user interface can be accessed through a client software program on the user's computers or the interface can be web based, as in one embodiment of the invention. Having a web-based interface allows users to access the electronic management interface from any computer with a web browser and a connection to the Internet. Access by users can be performed using wireless connections, cell phones, PDAs or any similar client system that is known to those skilled in the art.

The different user interfaces can include an electronic client interface 210. The electronic client interface is coupled to the cleaning management database and can be presented with a layout that is straightforward and easy for a client 206 to use. The information included in the interface can show the client comments and the status of these comments or requests. Communications to the client from a cleaning organization's management and supervisor can also be displayed here. The information can include the date of the comment or communication, when the comment was resolved, and how much the work to resolve the comment may cost. The client's view can also show work tickets and the status of those work tickets. A work ticket can be generated for work that is outside the scope of the client or customers original agreement. The client interface can also have a function that allows the client to search the database for prior work tickets and comments. The interface can also contain organizational information or other personal staff information for the cleaning organization. The client interface can also include an interface for a member of the client's staff 202.

The present invention can include a supervisor interface 212. The supervisor interface allows a supervisor to access comments or requests from the client. These comments or requests can be provided in the form of notifications or request reports. The notifications or request reports can be electronic instruction cards, printed instruction cards, or some other type of electronic report. The supervisor can also enter in responses to the cleaning comments in the form of a cleaning summary or a general response.

A management interface 214 is also included in the present invention. The management 204 can receive comments from the client in this interface. The manager can view information about the company organization, building, supervisor routes, cleaning people, and client administrators. The manager may view all clients and assign supervisors to routes and routes to cleaning people. A manager can create, edit, and modify instruction cards from this interface. The manager can also create new work tickets, view progress on current work tickets, view progress on comments, view and track cleaning person work information, reply to cleaning person comments, and search the database from this interface.

The cleaning management database includes historical cleaning records 216. The historical cleaning records are formed as previously described and contain information for what needs to be cleaned, what has been cleaned, what the problem areas are, and how the cleaning people have responded to comments, complaints, or work tickets.

Instruction cards 220 are also stored in the historical cleaning database. These cards tell the cleaning people exactly what cleaning should be done. The instruction cards can be systematically updated when cleaning comments are received and processed.

A search module 218 is included in the invention. The search module allows the client, a member of the client's staff, the cleaning organization manager, the supervisor, or even the cleaning person to search the historical cleaning records or search for instruction cards. The searches of historical cleaning records can be performed based on numerous different criteria as known to those skilled in the art.

A cleaning communication module 222 is included in the present invention. The cleaning communication module can send a comment or request entered by the client 206 to the cleaning organization management. The module may send the comment to the cleaning organization supervisor 208 and to the member of the client's staff 208. The module can also distribute work tickets, cleaning response summaries, and replies to all the appropriate parties.

One embodiment of the invention includes a speech converter module. The speech converter module utilizes analog to digital speech recognition processes well known to those skilled in the art to convert voice into an electronic text entry for storage in the cleaning management database. For example, a client can call in a comment or complaint to a recording mechanism for the cleaning management database. The recording mechanism converts the vocal comment or complaint into a text entry, and then the text entry is stored in a historical cleaning record. Alternatively, the recording can be stored in the database in audio format.

The invention can also include a text converter module. The text converter module converts cleaning management database text entries into audio entries. These audio entries can be sent to the voicemail boxes of clients, management, supervisors, cleaning persons, or a member of the client's staff. The text entries to be converted may be the comment or complaint, the response to the comment or complaint, a work ticket, or another communication between the cleaning organization and the client.

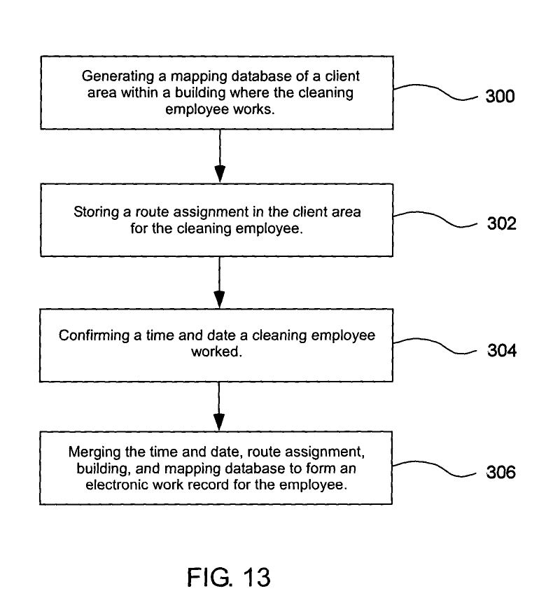

The system can also include cleaning tracking records that store a cleaning person's work schedules and locations. As shown in FIG. 13, a mapping database of a client area within a building where the cleaning person works is generated 300. This information can be recorded in the cleaning management database. The step of storing a route assignment in the client area for the cleaning person is performed 302. Further, a date and time a cleaning person worked is confirmed 304. Finally, a record is constructed by merging the time and date, the assignment, and mapping database to form an electronic work record for the cleaning person 306. If a cleaning person is sick, on vacation, or doesn't show up, a record of who actually performed the work is stored in the cleaning management database. This allows complete cleaning person performance tracking. Since a complaint is logged down to the cleaning person in a given area, the cleaning management and the client know who to hold responsible for the problem. These electronic work records can be stored in the electronic management database and access to the work records can be provided to a cleaning organization managers and supervisor.

One benefit of keeping electronic cleaning person tracking records is that it helps increase a cleaning person's accountability for performing the services outlined in the instruction cards and client cleaning agreement. Detailed performance reviews of cleaning persons can be performed based in part on feedback from the clients. Payroll function such as tracking vacation, time worked, and sick leave can be assessed using this system. It also provides the benefit of customizable training for cleaning persons based on complaints logged for them. One additional valuable feature of the detailed cleaning person management is the improved security. If items are broken, missing, or stolen, the database tracks exactly what cleaning persons were where and when they were at a given location.

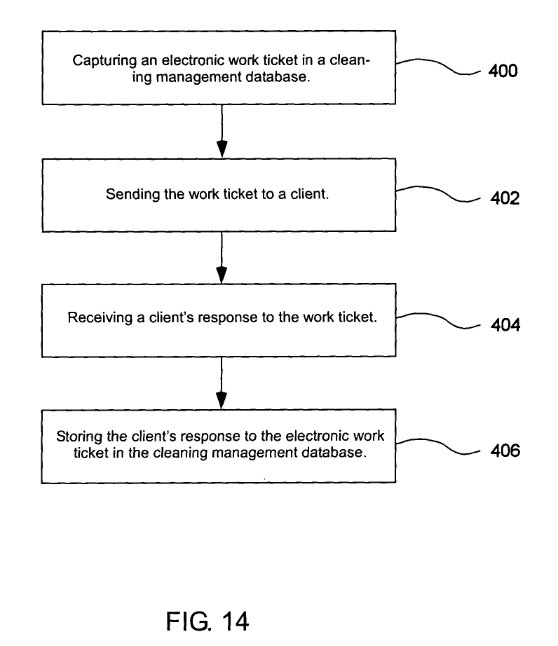

The invention can also enable the supervisor or lead to send electronic work tickets, as shown in FIG. 14. An electronic work ticket is captured in the cleaning management database 400. Extra work observations can be generated in the form of work tickets from within a cleaning organization as a possible source of additional revenue. The work ticket is then sent to a client 402, and a manager can direct a cleaning management module to route the work ticket to the appropriate client. When the client receives the work ticket, this enables them to confirm whether they would like to pay for the work outlined in the work ticket to be performed. The client's response to the work ticket is received 404, and this response is stored in the cleaning management database 406. When a supervisor generates a work ticket, the supervisor and the cleaning organization can benefit from the generation of additional work and the client can have cleaner facilities

Work tickets can also be generated by the cleaning organization's management and then approved or denied by the cleaning organization's clients. Clients have the ability to delegate work ticket approval among the basic user hierarchy. Clients can also place dollar amount limits on subordinates so they do not authorize large expenditures. The program logs the bid and the approval process, which is viewable by the client, the management, or higher management at any time. The client is not billed until they “sign off” that the work has been completed in an acceptable manner.

If the work ticket is approved, this approval is stored in the electronic management database and the work ticket approval is routed to a supervisor by a manager. The manager can direct the cleaning management module to forward the work ticket approval to the supervisor. The cleaning person then does the work and electronic approval for the work as given by the client can be saved in the electronic management database. Once the approval is given for the work done, the work ticket can be sent out for billing. Access can be provided to the electronic work ticket or to past electronic work tickets for the client, the manager, the supervisor, or a member of the client's staff. Reviewing the record of work tickets can help cleaning organization's managers and supervisors draft more detailed contracts with future clients. These contracts can include cleaning ideas saved as work tickets in the cleaning management database.

The present invention provides a cleaning management database that can help cleaning management companies have effective and timely communication with their clients. The embodiments of the present invention presented can also help a cleaning management company provide thorough cleaning and quality customer service to their clients.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for electronically managing a cleaning organization and cleaning services rendered thereby to clients, comprising the steps of:
capturing an electronic comment from a client relating to a cleaning area serviced by a cleaning person within the cleaning organization;
storing the electronic comment in a cleaning management database as part of a historical cleaning record;
sending the electronic comment to a manager of the cleaning organization;
classifying the electronic comment as part of a data group file with similar comments;
communicating the electronic comment to a supervisor responsible for the cleaning area; and
providing the cleaning person with notification of the comment from the cleaning management database.

2. The method as in claim 1, further comprising the step of replying to the electronic comment with a cleaning summary from the cleaning organization.

3. The method as in claim 1, wherein the step of sending the electronic comment to a cleaning organization's management further comprises the step of sending the electronic comment to first and second level managers of the cleaning organization.

4. The method as in claim 3, further comprising the step of enabling the second level manager to use a cleaning management module to route the electronic comment to the supervisor.

5. The method as in claim 1, further comprising the step of sending the electronic comment to a franchisor and a franchisee of the cleaning organization.

6. The method as in claim 1, further comprising the steps of:
attaching a cleaning summary of the cleaning person to the notification received by the cleaning person;
storing the cleaning summary as part of the historical cleaning record;
directing the cleaning management module to send the cleaning summary to the management of the cleaning organization; and
sending a reply to the client based on the cleaning summary from the manager of the cleaning organization, wherein the reply is routed to the client by the cleaning management module and stored in the cleaning management database as part of the historical cleaning record.

7. The method as in claim 1, wherein the step of storing the electronic comment further comprises the step of assigning the electronic comment to an instruction card used by the cleaning person in performing cleaning duties.

8. The method as in claim 1, further comprising the step of providing the supervisor, the manager of the cleaning organization, and assigned users of the client with access to the historical cleaning record.

9. The method as in claim 1, further comprising the step of distributing the historical cleaning record to the supervisor, the manager of the cleaning organization, and the client.

10. The method as in claim 9, wherein the step of distributing the historical cleaning record further comprises the step selected from the group consisting of emailing the historical cleaning record and telephoning the historical cleaning record.

11. The method as in claim 1, further comprising the step of searching historical cleaning records.

12. The method as in claim 11, wherein the step of searching historical cleaning records further comprises the step selected from the group consisting of searching the historical cleaning records by subject, searching the historical cleaning records by building, searching the historical cleaning records by cleaning person, and searching the historical cleaning records by comment.

13. A method as in claim 1, wherein the step of capturing an electronic comment further comprises the step of capturing an electronic complaint.

14. A method for electronically managing a cleaning organization, comprising:
receiving an electronic request from a client by a cleaning organization manager;
routing the electronic request to an electronic instruction card that covers a cleaning area associated with the electronic request;
updating the electronic instruction card to include the electronic request; and
printing the electronic instruction card with the electronic request to insure complete resolution of the original request.

15. A method as in claim 14, further comprising the step of providing customized training based on the instruction card.

16. A system for electronically tracking cleaning, comprising:
a cleaning management database to store cleaning comments and responses to cleaning comments;
a client interface coupled to the cleaning management database, the client interface being configured to allow a client to enter cleaning comments into the cleaning management database;
a management interface coupled to the cleaning management database, and the management interface is configured to allow a manager to enter cleaning results into the database;
a supervisor interface coupled to the cleaning management database, and the supervisor interface is configured to allow a supervisor to view cleaning results and enter cleaning results into the database; and
a cleaner communication module coupled to the cleaning management database in order to distribute cleaning data to clients.

17. A system as in claim 16, further comprising a speech converter module, wherein the speech converter module can convert voice entries from a client into electronic text entries for storage in the cleaning management database.

18. A system as in claim 16, further comprising a text converter module, wherein the text converter module can convert cleaning management database text entries into audio messages for distribution to clients and to managers and supervisors of the cleaning organization.

19. A system as in claim 16, further comprising an instruction card that is updated with cleaning comments that are received and processed.

20. A system as in claim 16, further comprising cleaning person tracking records that store cleaning persons' work schedules in order to track when cleaning persons are working on a cleaning route.

21. A system as in claim 16, further comprising a search module that allows clients, managers, and supervisors to search the electronic cleaning management database for cleaning comments.

22. A system as in claim 16, further comprising a telephone navigation menu that provides access to the cleaning management database over the telephone.

23. A method for electronically enhancing security and tracking of a cleaning person, comprising the steps of:
generating a mapping database of a client area within a building where the cleaning person works;
storing a route assignment in the client area for the cleaning person;
confirming a time and date a cleaning person worked;
merging the time and date, the route assignment, building, and mapping database to form an electronic work record for the cleaning person in order to enhance management tracking of an cleaning person.

24. A method as in claim 23, further comprising the step of storing the electronic work record in an electronic management database.

25. A method as in claim 23, further comprising the step of providing managers and supervisors of a cleaning organization with access to the electronic work record.

26. A method as in claim 23, further comprising the step of using the information from the electronic work record in performance reviews.

27. A method for managing cleaning work tickets, comprising the steps of:
capturing an electronic work ticket in a cleaning management database;
sending the work ticket to a client in order to enable the client to confirm whether the client would like the work ticket to be performed;
receiving a client's response to the work ticket; and
storing the client's response to the electronic work ticket in the cleaning management database.

28. A method as in claim 27, wherein the step of capturing an electronic work ticket further comprises the step of generating the electronic work ticket with a survey.

28. A method as in claim 27, further comprising the step of setting dollar amount limits for work tickets in the cleaning management database.

29. The method as in claim 27, wherein the step of storing the client's response to the electronic work ticket further comprises the step of storing a client's authorization to perform work outlined in the work ticket.

30. The method as in claim 29, further comprising the steps of:
directing a cleaning person to perform duties outlined in the work ticket;
saving a client's electronic approval of work performed by the cleaning person on the work ticket in the cleaning management database; and
sending the work ticket out for billing after the client gives electronic approval for the cleaning person's work.

31. The method as in claim 30, further comprising the step of providing the client, the manager, and the supervisor with access to the electronic work ticket.
